(19) United States
(12) Patent Application Publication
(10) Pub. No.: US 2013/0196194 A1
(43) Pub. Date: Aug. 1, 2013

(54) SECONDARY BATTERY

(71) Applicant: Yong-Kyun PARK, Yongin-si (KR)

(72) Inventor: Yong-Kyun PARK, Yongin-si (KR)

(73) Assignee: SAMSUNG SDI CO., LTD., Yongin-si (KR)

(21) Appl. No.: 13/586,332

(22) Filed: Aug. 15, 2012

Related U.S. Application Data
(60) Provisional application No. 61/592,873, filed on Jan. 31, 2012.

(51) Int. Cl. H01M 4/64; H01M 2/36; H01M 2/14

(52) U.S. Cl. 429/72; 429/149; 429/129

(57) ABSTRACT

A secondary battery that includes at least two electrode assemblies positioned in parallel and having a space between the electrode assemblies. Further, the secondary battery includes at least two electrode tabs contained within the at least two electrode assemblies. A battery case is provided having at least one accommodating portion containing the at least two electrode assemblies.

### CLAIM OF PRIORITY

This application claims priority to and the benefit of Provisional Application No. 61/592,873, filed on 31 Jan. 2012, in the United States Patent and Trademark Office, the entire content of which is incorporated herein by reference.

### BACKGROUND OF THE INVENTION

1. Field of the Invention

The present invention generally relates to a secondary battery.

2. Description of the Related Art

In general, secondary batteries are used to supply energy to portable electronic devices. As the electronic devices are developed, the secondary batteries require high capacity and high efficiency.

The above information disclosed in this Related Art section is only for enhancement of understanding of the background of the invention and therefore it may contain information that does not form the prior art that is already known to a person of ordinary skill in the art.

### SUMMARY OF THE INVENTION

Embodiments provide a secondary battery having improved energy efficiency by being manufactured to have a new structure.

Embodiments also provide a secondary battery having improved process efficiency by simplifying a manufacturing process thereof. According to an aspect of the present invention, a secondary battery is provided having at least two electrode assemblies positioned in parallel and having a space between the electrode assemblies; at least two electrode tabs contained within the at least two electrode assemblies, and a battery case having at least one accommodating portion containing the at least two electrode assemblies.

The secondary battery may include the electrode tabs exit a first of the at least two electrode assemblies and enter a second of the at least two electrode assemblies, the electrode tabs may extend through the second of the at least two electrode assemblies and exit the battery case.

The secondary battery may further include a spacer contained within the space between the electrode assemblies.

The secondary battery may further have the spacer containing at least two mounting portions accommodating the electrode tabs on at least one surface of the spacer.

The secondary battery may further have the spacer containing at least two mounting portions accommodating said electrode tabs in an interior of the spacer.

The secondary battery may further have the at least two mounting portions include at least one orifice in the spacer.

The secondary battery may further have the at least one accommodating portion of the battery case, including: a first accommodating portion containing a first of the at least two electrode assemblies; and a second accommodating portion containing a second of the at least two electrode assemblies. The first and second accommodating portions may be separated from each other via sealing portions within the battery case.

The secondary battery may further have the first accommodating portion has approximately a size and shape of the first electrode assembly and a second accommodating portion has approximately the size and shape of the second electrode assembly.

The secondary battery may further have the electrode tabs extend through longitudinally opposite sides of the battery case and through both of the two electrode assemblies disposed between the longitudinally opposite sides.

The secondary battery may further include an electrolyte storage portion located between the first and the second accommodating portions.

The secondary battery may further have the battery case further including: a cover; a main body; and a sealing portion formed by sealing at least a portion of the cover and at least a portion of the main body. The cover and main body may have affixed an electrolyte injection portion for injection of electrolyte into the battery case.

The secondary battery may further have the electrolyte injection portion connected to the space between the first and the second of the electrode assemblies.

The secondary battery may further include a safety member provided in the battery case positioned to correspond to the space.

The secondary battery may further have the electrolyte injection portion include the sealing portion.

The secondary battery may further have the spacer containing at least two mounting portions on at least one surface of the spacer accommodating the electrode tabs.

The secondary battery may further have the at least two mounting portions include at least one orifice in the spacer.

The secondary battery may further have the at least two mounting portions having a same shape as each of the electrode tabs.

The secondary battery may further have the electrolyte storage portion containing electrolyte.

As described above, according to the present invention, it is possible to provide a secondary battery having improved energy efficiency by being manufactured to have a new structure.

Further, it is possible to provide a secondary battery having improved process efficiency by simplifying a manufacturing process thereof.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view of a secondary battery according to an aspect of an embodiment of the present invention.

FIG. 2 is an exploded perspective view of the secondary battery of FIG. 1.

FIG. 3 is a sectional view taken along line I-IA of the secondary battery of FIG. 1.

FIG. 4 is an exploded perspective view of a secondary battery according to another aspect of the embodiment illustrated in FIG. 1 of the present invention.

FIG. 5A is a perspective view of an embodiment of a spacer of FIG. 4.

FIG. 5B is a front view of the spacer of FIG. 5A.

FIG. 6A is a perspective view of another embodiment of the spacer.

FIG. 6B is a front view the spacer of FIG. 6A.

FIG. 7 is an exploded perspective view of a secondary battery according to another embodiment of the present invention.

FIG. 8 is a sectional view of the secondary battery of FIG. 7.

FIG. 9A is a perspective view of a secondary battery according to another embodiment of the present invention.

FIG. 9B is an exploded perspective view of the secondary battery of FIG. 9A.

FIG. 9C is an exploded perspective view of the secondary battery of FIG. 9A that includes a spacer.

FIG. 9D is an exploded perspective view of the secondary battery of FIG. 9A that includes a spacer.

FIG. 10 is a sectional view taken along line II-II of the secondary battery of FIG. 9A.

FIG. 11 is a perspective view of a secondary battery according to another embodiment of the present invention.

FIG. 12 is a sectional view taken along line III-III of the secondary battery of FIG. 11.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to another element or be indirectly connected to the another element with one or more intervening elements interposed therebetween. Alternatively, when an element is referred to as being “directly on” another element, there are no intervening elements present. Hereinafter, like reference numerals refer to like elements.

Recognizing that sizes and thicknesses of constituent members shown in the accompanying drawings are arbitrarily given for better understanding and ease of description, the present invention is not limited to the illustrated sizes and thicknesses.

In the drawings, the thickness of layers, films, panels, regions, etc., are exaggerated for clarity. In order to clarify the present invention, elements extrinsic to the description are omitted from the details of this description.

In several exemplary embodiments, constituent elements having the same configuration are representatively described in a first exemplary embodiment by using the same reference numeral and only constituent elements other than the constituent elements described in the first exemplary embodiment will be described in other embodiments.

Hereinafter, embodiments of the present invention will be described with reference to the accompanying drawings.

In general, the external appearance of a secondary battery may be variously modified depending on an electronic device employing the secondary battery. As electronic devices such as a smart phone have recently been developed, a secondary battery is frequently used, which has double width and long length rather than thin thickness.

However, it is difficult to manufacture the secondary battery having double width and long length. In addition, the path along which electricity flows in the secondary battery is extended, and therefore, the efficiency of energy consumption is decreased.

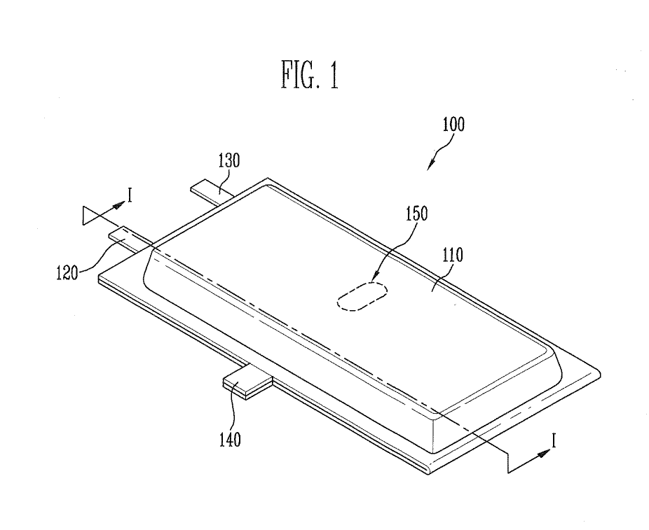

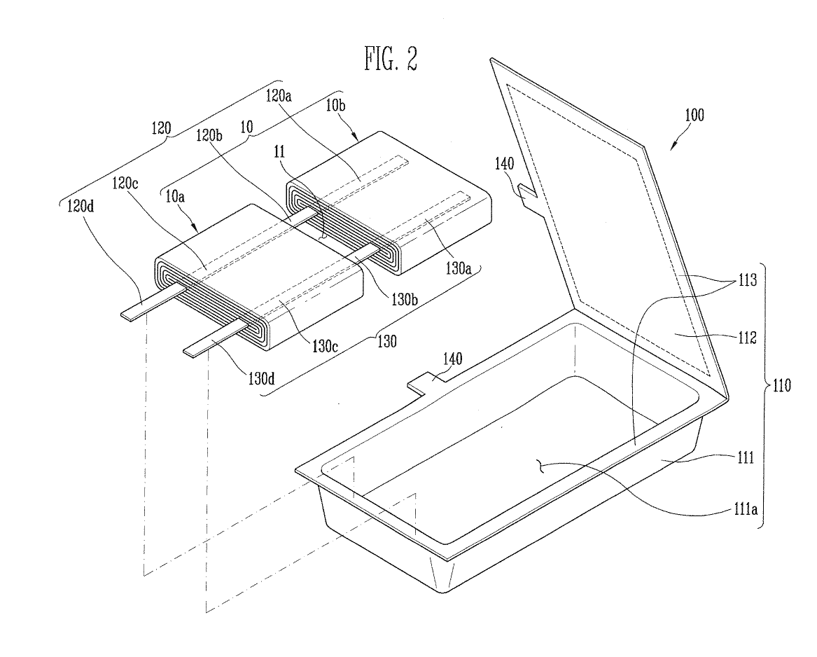

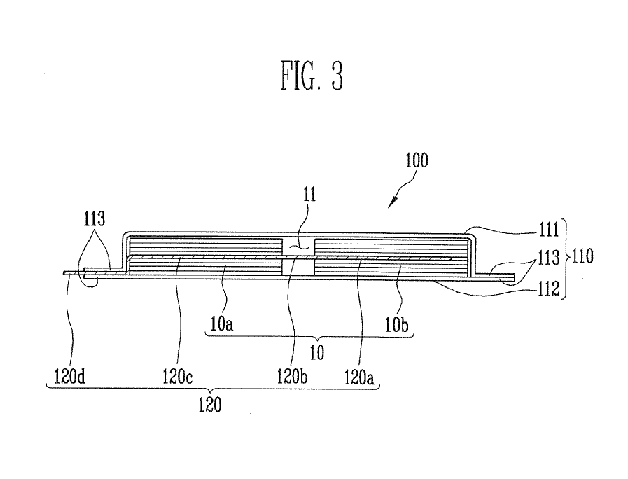

FIG. 1 is a perspective view of a secondary battery according to a first embodiment of the present invention. FIG. 2 is an exploded perspective view of the secondary battery of FIG. 1. FIG. 3 is a sectional view taken along line I-I of the secondary battery of FIG. 1.

The secondary battery 100 according to this embodiment includes an electrolyte; two or more electrode assemblies 10 each having a first electrode plate, a second electrode plate opposite to the first electrode plate, and a separator interposed between the first and second electrode plates; and a battery case 110 in which the electrolyte and the electrode assemblies are accommodated. In the battery case 110, neighboring electrode assemblies 110 may be provided in parallel with each other.

The electrode assembly 10 may have first and second electrode plates having different polarities from each other, and a separator. For example, the first electrode plate may be a positive electrode plate formed by coating a positive electrode active material including lithium on a base plate, and the second electrode plate may be a negative electrode plate formed by coating a negative electrode active material including carbon on a base plate. The separator may be interposed between the first and second electrode plates so as to prevent the first and second electrode plates from contacting directly with each other. The separator may include a plurality of pores that constitute a path of ions or the electrolyte.

The electrolyte may be accommodated together with the electrode assemblies 10 in the battery case 110. In this case, the electrolyte facilitates the movement of current between the first and second electrode plates. For example, the electrolyte may include a lithium salt acting as a supply source of lithium ions and a non-aqueous organic solvent acting as a medium through which ions participating in an electrochemical reaction can move.

The battery case 110 may include a pouch composed of a main body 111 and a cover 112. Here, the main body has an accommodating portion 111a that is a space for accommodating the electrode assemblies 10 and the electrolyte. The accommodating portion 111a in the main body 111 accommodates the electrode assemblies 10 and the electrolyte, and the main body 111 may be sealed with the cover 112 so as to prevent the electrode assemblies 10 and the electrolyte from being separated therefrom. In this case, sealing portions 113 may be provided at edges of the main body 111 and the cover 112, corresponding to each other. The sealing portions 113 are thermally bonded in the state in which the main body 111 and the cover 112 are adhered closely to each other.

Generally, the external appearance of a secondary battery used as a power source of an electronic device may be determined according to the external appearance of the electronic device. Recently, a demand on secondary batteries each having double width and long length has been increased. A secondary battery having double width and long length is light in weight and small in size. On the other hand, the secondary battery is rapidly deteriorated, and therefore, the lifespan of the secondary battery is reduced. Specifically, it is not easy to perform a reversible electrochemical reaction between an electrode assembly and an electrolyte, which enables the reversible use of the secondary battery. Therefore, this results in the deterioration of the secondary battery. The electrode assembly manufactured to have double width and long length has a low permeation property of the electrolyte, and a part into which the electrolyte is permeated occurs in a partial section of the electrode assembly. Therefore, the movement of electrons or ions is unbalanced, which results in a side reaction. As a result, the secondary battery is deteriorated.

Embodiments of the present invention provide a secondary battery in which the permeation property of an electrolyte with an electrode assembly, so that it is possible to prevent the deterioration of the secondary battery and to increase the lifespan of the secondary battery. In the secondary battery, having double width and long length, there is no region in which the electrolyte is not permeated into the electrode assembly. Thus, a side reaction does not occur, and the secondary battery can be efficiently used.

The electrode assembly 10 may include first and second electrode assemblies 10a and 10b, and the first and second electrode assemblies 10a and 10b may be provided in parallel with each other in the battery case 110. The first and second electrode assemblies 10a and 10b. The first and second electrode assemblies 10a and 10b are provided adjacent to each other while being spaced apart from each other, and a space portion 11 may be provided between the first and second electrode assemblies 10a and 10b. The space portion 11 may be connected to an electrolyte injection portion 140, and a safety member 150 may be further provided to the battery case 110.

The safety member 150 may be provided to at least one of the main body 111 and cover 112 of the battery case 110. For example, the safety member 150 may include a vent for exhausting gas when the internal pressure of the secondary battery 100 may be a predetermined value or more. The safety member 150 prevents the secondary battery 100 from being exploded due to a sudden increase of the internal pressure, or the like, so that it is possible to improve the safety of the secondary battery 100.

The electrolyte injection portion 140 may be connected to an edge of the battery case 100 so as to act as a path along which the electrolyte may be injected into the battery case 110. Since the electrolyte injection portion 140 is a part used to inject the electrolyte into the battery case 110, the electrolyte injection portion 140 may be provided at a central part of the battery case 110. The electrolyte injection portion 140 may be removed after the electrolyte may be injected into the battery case 110 there through. Since the electrolyte injection portion 140 is provided to injection the electrolyte into the battery case 110 therethrough, the electrolyte injection portion 140 may be provided in various shapes.

The electrolyte injection portion 140 may be connected to the space portion 11 between the first and second electrode assemblies 10a and 10b. The electrolyte may be injected into the battery case 110 through the electrolyte injection portion 140 and then divided to both sides in the space portion 11. Thus, the electrolyte can be permeated into the first and second electrode assemblies 10a and 10b. Since the electrolyte is efficiently permeated into the first and second electrode assemblies 10a and 10b, there exists no region in which the electrolyte is not permeated into the first and second electrode assemblies 10a and 10b. The surplus of electrolyte remaining after being permeated into the first and second electrode assemblies 10a and 10b may be provided in the space portion 11 between the first and second electrode assemblies 10a and 10b. The electrolyte provided in the space portion 11 may be supplied to the first and second electrode assemblies 10a and 10b when the electrolyte is exhausted by a plurality of charging/discharging operations of the secondary battery 100, and thus the lifespan of the secondary battery can be improved.

The electrode assembly 10 may include a first electrode tab 120 provided to the first electrode plate and a second electrode tab 130 provided to the second electrode plate. The first and second electrode tabs 120 and 130 may be protruded to the outside of the battery case 110. For example, the first and second electrode assemblies 10a and 10b are provided with first and second electrode tabs 120 and 130, and the electrode tabs 120 and 130 may be extended from the second electrode assembly 10b so as to be protruded to the outside of the battery case 110 via the first electrode assembly 10a. The first and second electrode tabs 120 and 130 act as a path of current (or electrons) generated in the first and second electrode assemblies 10a and 10b. In this case, the first and second electrode tabs 120 and 130 may be sequentially divided into first to fourth portions 120a, 120b, 120c, 120d, 130a, 130b, 130c and 130d, respectively. The first portions 120a and 130a of the first and second electrode tabs 120 and 130 are connected to the first and second electrode plates of the second electrode assembly 10b. The second portions 120b and 130b of the first and second electrode tabs 120 and 130 are extracted to the outside of the second electrode assembly 10b so as to correspond to the space portion 11 between the first and second electrode assemblies 10a and 10b. The third portions 120c and 130c of the first and second electrode tabs 120 and 130 are connected to the first and second electrode plates of the first electrode assembly 10a, and the fourth portions 120d and 130d of the first and second electrode tabs 120 and 130 are extracted from the first electrode assembly 10a so as to be exposed to the outside of the battery case 110. For example, the first and second electrode tabs 120 and 130 may be positive and negative electrode tabs, respectively. The first and second electrode tabs 120 and 130 can electrically connect the first and second electrode assemblies 10a and 10b spaced apart from each other.

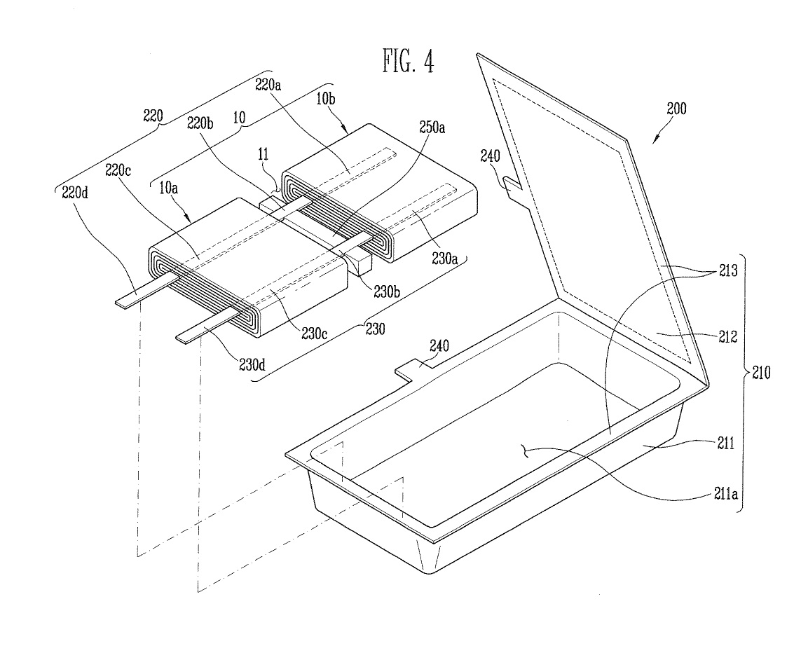

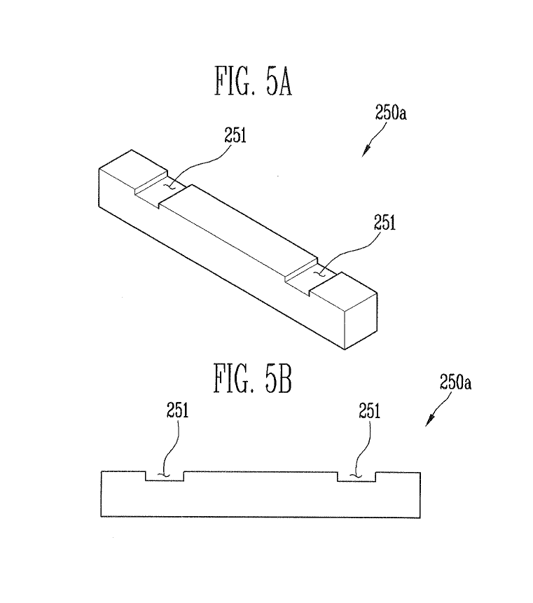

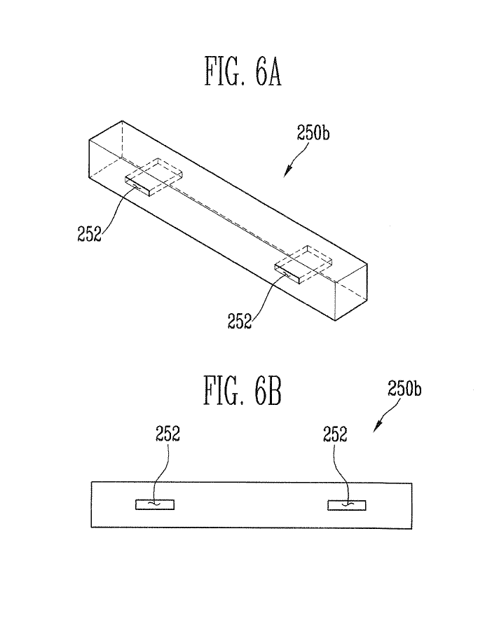

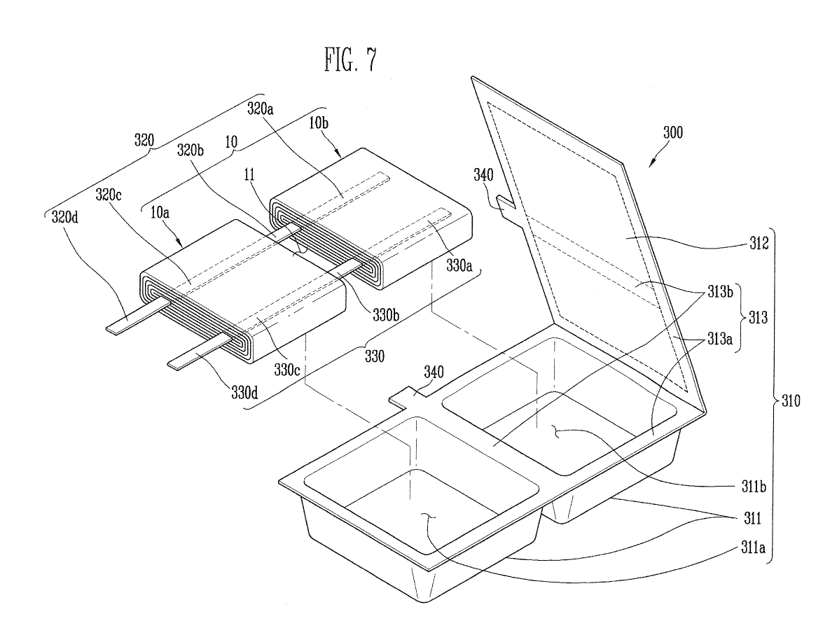

FIG. 4 is an exploded perspective view of a secondary battery according to another aspect of the first embodiment of the present invention. FIG. 5A is a perspective view of an embodiment of a spacer of FIG. 4. FIG. 5B is a front view of the spacer of FIG. 5A. FIG. 6A is a perspective view of another embodiment of the spacer. FIG. 6B is a front view of the spacer of FIG. 6A.

Referring to FIGS. 4 to 6B, alternatively, the secondary battery 200 may further include at least one spacer 250a. The spacer 250a may be provided between the first and second electrode assemblies 10a and 10b, and first and second electrode-tab mounting portions 251 on which first and second electrode tabs 220 and 230 are mounted, respectively, may be provided to the spacer 250a. The first and second electrode assemblies 10a and 10b are accommodated in parallel in an accommodating portion 211a of a main body 211 of a battery case 210 and then sealed by a cover 212 of the battery case 210. Second portions 220b and 230b of the first and second electrode tabs 220 and 230 may be positioned in the space portion 11 between the first and second electrode assemblies 10a and 10b. In this case, an electrolyte injection portion 240 may be provided at an edge of the battery case 210 so as to correspond to the space portion 11, and fourth portions 220d and 230d of the first and second electrode tabs 220 and 230 are protruded to the outside of the battery case 210.

Although the spacer 250a shown in FIGS. 5A and 5B is used in the secondary battery of FIG. 4, a spacer 250b shown in FIGS. 6A and 6B may be used in the secondary battery of FIG. 4. Hereinafter, the spacer 250a shown in FIGS. 5A and 5B is referred to as a first spacer 250a, and the spacer 250b shown in FIGS. 6A and 6B is referred to as a second spacer 250b.

The first or second spacer 250a or 250b may be provided between the first and second electrode assemblies 10a and 10b. In this case, the first or second spacer 250a or 250b may be a part that comes in contact with the second portions 220b and 230b of the first and second electrode tabs 220 and 230, and first or second electrode-tab mounting portions 251 or 252 through which the second portions 220b and 230b of the first and second electrode tabs 220 and 230 pass, respectively, may be provided to the first or second spacer 250a or 250b. For example, the first or second electrode-tab mounting portion 251 or 252 may be provided to have a step difference or may be provided in the shape of a through-hole.

The spacer 250a or 250b may be made of an insulating material so as to be provided in the space portion 11 between the first and second electrode assemblies 10a and 10b. Thus, the spacer 250a or 250b insulates between the first and second electrode assemblies 10a and 10b, so that it is possible to prevent the risk of a short circuit, or the like. Further, since the spacer 250a or 250b enables the first and second electrode tabs 220 and 230 to be firmly fixed by supporting the first and second electrode tabs 220 and 230, current can smoothly flow through the first and second electrode tabs 220 and 230.

Hereinafter, other embodiments of the present invention will be described with reference to FIGS. 7 to 12. Components in these embodiments described with reference to FIGS. 7 to 12 are similar to those in the embodiment described with reference to FIGS. 1 to 6B, and therefore, their detailed descriptions will be omitted.

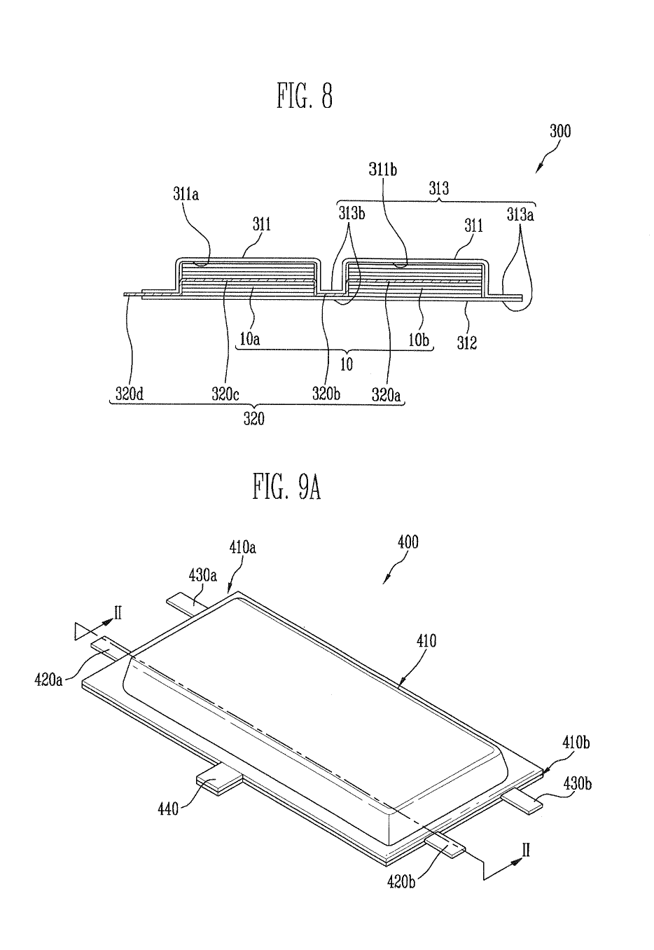

FIG. 7 is an exploded perspective view of a secondary battery according to a second embodiment of the present invention. FIG. 8 is a sectional view of the secondary battery of FIG. 7.

Referring to FIGS. 7 and 8, in the secondary battery 300 according to this embodiment, a battery case 310 may include one or more accommodating portions 311a and 311b provided to correspond to the shape of the electrode assembly 10. The accommodating portions 311a and 311b are provided to a main body 311 so as to respectively accommodate the first and second electrode assemblies 10a and 10b. The accommodating portions 311a and 311b include first and second accommodating portions 311a and 311b. The first and second accommodating portions 311a and 311b are spaced apart from each other, and may be provided to respectively correspond to the sizes of the first and second electrode assemblies 10a and 10b.

External sealing portions 313a are respectively provided at edges of the main body 311 and a cover 312 in the battery case 310 so as to seal the battery case 310. In this case, an internal sealing portion 313b may be provided between the first and second accommodating portions 311a and 311b, and thus the first and second accommodating portions 311a and 311b can be spaced apart from each other by the internal sealing portion 313b.

An electrolyte injection portion 340 may be provided in parallel with the internal sealing portion 313b at an outside of the battery case 310. The secondary battery 300 may be sealed by thermally bonding the external sealing portions 313a except the part connected to the electrolyte injection portion 340, and an electrolyte may be then injected into the battery case 310 through the electrolyte injection portion 340. Subsequently, the internal sealing portion 313b is sealed, thereby manufacturing the secondary battery 300.

The battery case 310 according to this embodiment may be composed of the plurality of accommodating portions 311a and 311b provided to correspond to the size of the electrode assembly 10, so that the electrode assembly 10 can be stably fixed in the battery case 310. Thus, the electrode assembly 10 may be stably fixed without moving due to an external impact such as a vibration or drop, thereby preventing an electrical short circuit, or the like. Further, the internal sealing portion 313b may be further provided between the first and second accommodating portions 311a and 311b, thereby improving the sealing performance of the secondary battery 300.

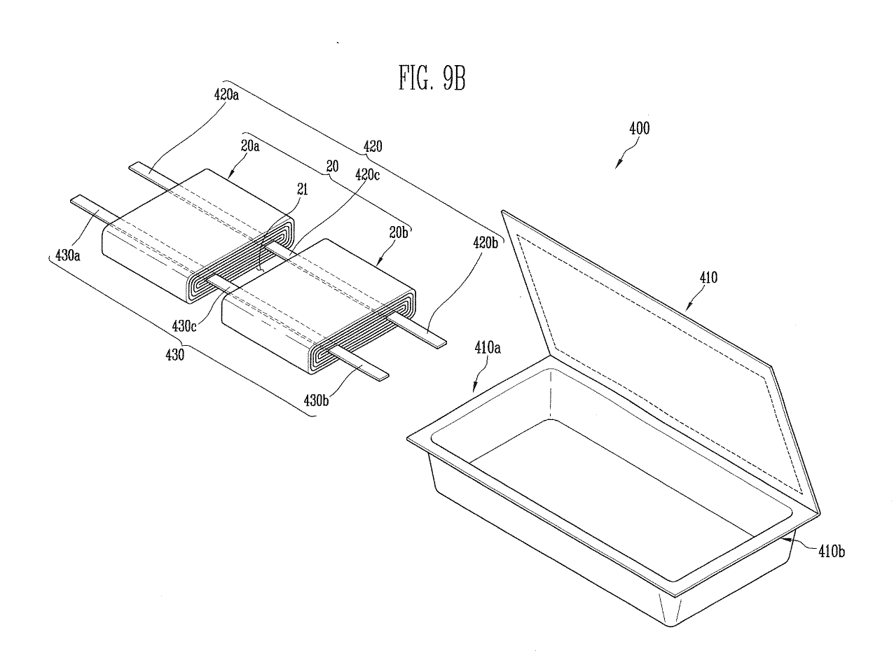

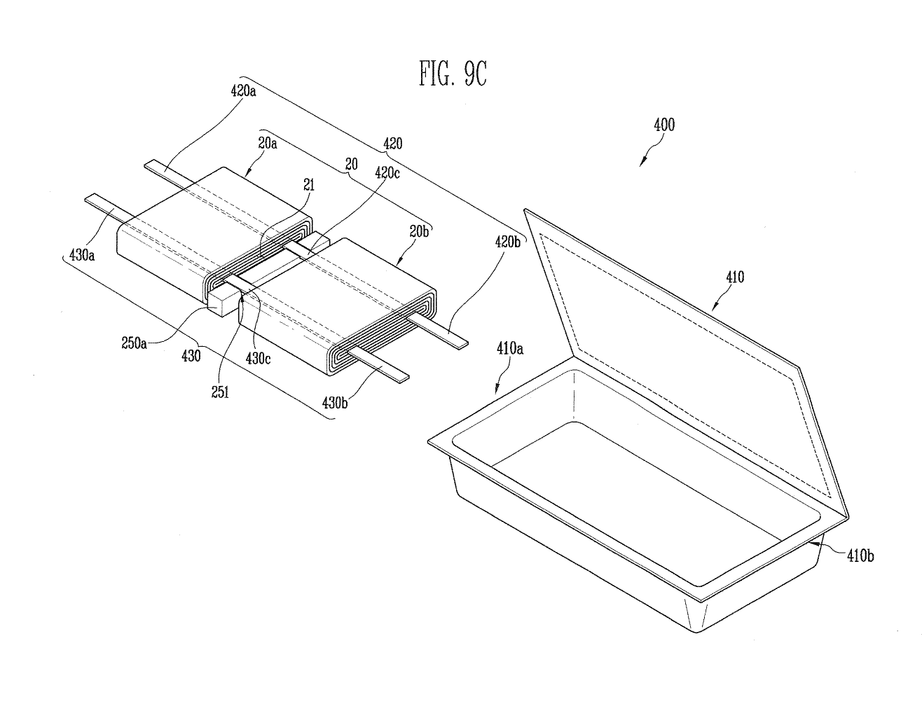

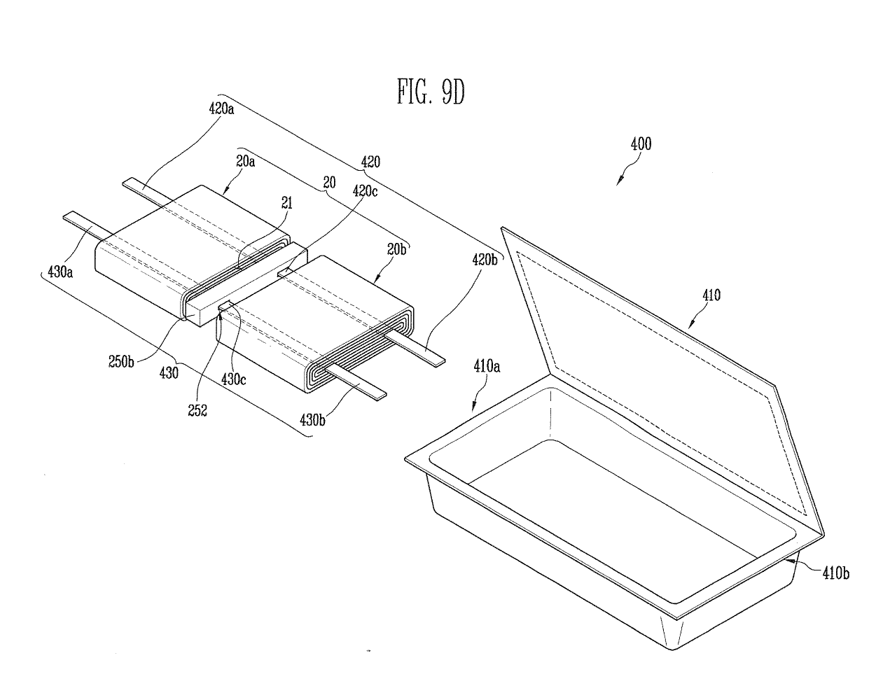

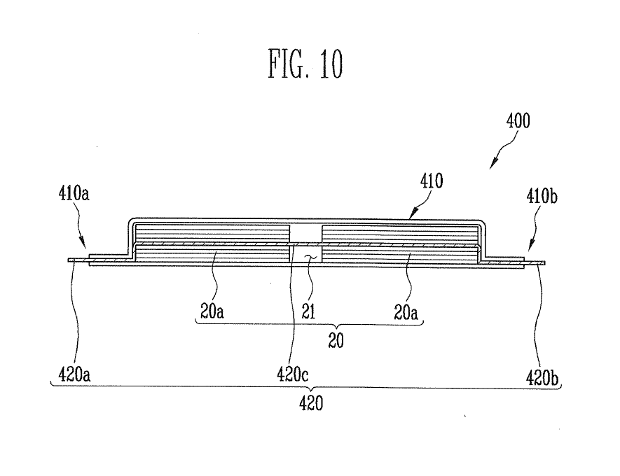

FIG. 9A is a perspective view of a secondary battery according to a third embodiment of the present invention. FIG. 9B is an exploded perspective view of the secondary battery of FIG. 9A. FIG. 9C is an exploded perspective view of the secondary battery of FIG. 9A that includes a spacer 420c. FIG. 9D is an exploded perspective view of the secondary battery of FIG. 9A that includes a spacer 420c. FIG. 10 is a sectional view taken along line II-II of the secondary battery of FIG. 9A.

Referring to FIGS. 9A to 10, the secondary battery 400 according to this embodiment may include a pair of first and second electrode tabs 420a and 430a protruded from one end 410a of a battery case 410, and a pair of first and second electrode tabs 420b and 430b protruded from the other end 410b opposite to the one end 410a of the battery case 410. First and second electrode assemblies 20a and 20b may be arranged in parallel while being spaced apart from each other with a space portion 21 interposed therebetween in the battery case 410.

First and second electrode tabs 420 and 430 may be provided to the first and second electrode assemblies 20a and 20b. The first and second electrode tabs 420 and 430 may be provided to connect the first and second electrode assemblies 20a and 20b to each other. The first and second electrode tabs 420 and 430 may include first portions 420a and 430a extracted from one end of the first electrode assembly 20a, second portions 420b and 430b extracted from the other end of the second electrode assembly 20b so as to face the opposite direction to the first portions 420a and 430a, and third portions 420c and 430c provided to correct the first and second electrode assemblies 20a and 20b, respectively. The third portions 420c and 430c of the first and second electrode tabs 420 and 430 may be provided to pass through the space portion 21 of the battery case 410.

The battery case 410 may include an electrolyte injection portion 440 provided in parallel with the space portion 21. An electrolyte may be injected into the battery case 410 through the electrolyte injection portion 440 so as to be uniformly spread in the battery case 410. The electrolyte is uniformly permeated into the first and second electrode assemblies 20a and 20b. The secondary battery 400 according to this embodiment is provided with a plurality of first and second electrode tabs 420a, 420b, 430a and 430b, so that it is possible to perform charging/discharging operations at a high rate and to efficiently use the secondary battery 400.

Referring to FIGS. 9C and 9D, alternatively, the secondary battery 400 may further include at least one spacer 250a. The spacer 250a may be provided between the first and second electrode assemblies 20a and 20b. The spacer 250a illustrated in FIG. 9C is identical to that illustrated and previously discussed in reference to FIGS. 5A and 5B and will not be discussed in further detail here. The spacer 250a illustrated in FIG. 9D is identical to that illustrated and previously discussed in reference to FIGS. 6A and 6B and will not be discussed in further detail here.

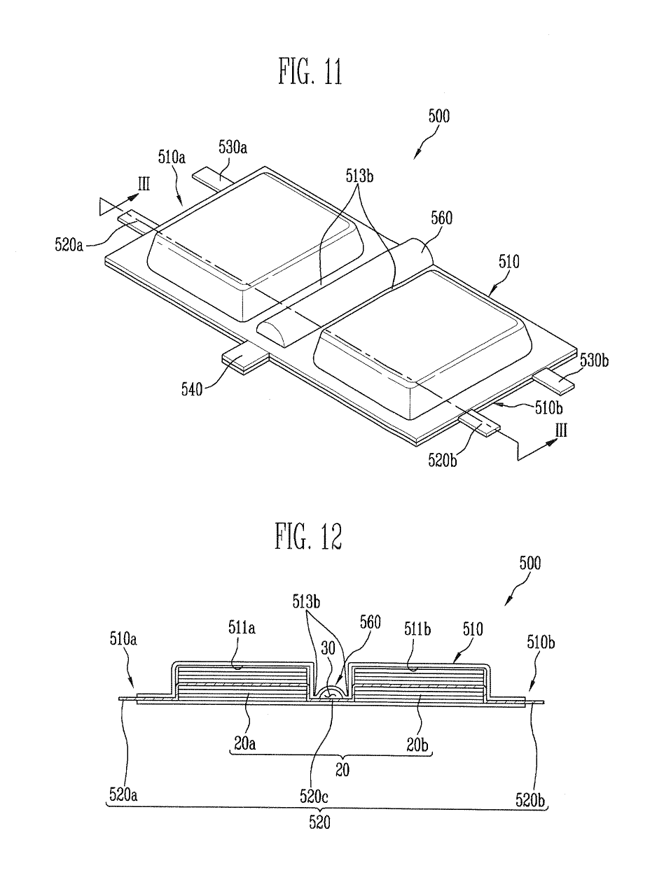

FIG. 11 is a perspective view of a secondary battery according to a fourth embodiment of the present invention. FIG. 12 is a sectional view taken along line III-III of the secondary battery of FIG. 11.

Referring to FIGS. 11 and 12, in the secondary battery 500 according to this embodiment, a battery case 510 may further include an electrolyte storage portion 560 in which an electrolyte 30 may be stored between the first and second electrode assemblies 20a and 20b. An electrolyte injection portion 540 may be provided to the battery case 510 so as to be connected to the electrolyte storage portion 560. Pairs of first and second electrode tabs 520a, 520b, 530a and 530 may be extracted from one and the other ends 510a and 510b of the battery case 510, respectively.

As a secondary battery is charged and discharged several times, the electrolyte is exhausted by side reactions, and therefore, the lifespan of the secondary battery is decreased. On the other hand, in the secondary battery 500 according to this embodiment, surplus electrolyte 30 may be stored in the electrolyte storage portion 560. Thus, the secondary battery 500 in which the electrolyte is exhausted due to its use for a certain period of time can use the electrolyte stored in the electrolyte storage portion 560 for the purpose of supplement, thereby increasing the lifespan of the secondary battery 500.

The electrolyte storage portion 560 may be provided using a process such as deep drawing. In the battery case 510, one or more internal sealing portions 513b may be provided between the electrolyte storage portion 560 and first and second accommodating portions 511a and 511b for respectively accommodating the first and second electrode assemblies 20a and 20b therein. The internal sealing portions 513b are sealed, for example, by thermal bonding. In this case, the first and second electrode tabs 520c and 530c for connecting the first and second electrode assemblies 20a and 20b to each other are provided to pass through the internal sealing portions 513b and then thermally bonded.

The internal sealing portion 513b allows spaces between the electrolyte storage portion 560 and the first and second accommodating portions 511a and 511b to be sufficiently bonded, but the degree of bonding in the internal sealing portion 513b may be changed depending on a position. A structural step difference may be formed by the difference in thickness between the first and second electrode tabs 520c and 530c in the internal sealing portion 513b, and the step difference acts as interference in the bonding of the internal sealing portion 513b. Therefore, the degree of sealing of the parts through which the first and second electrode tabs 520c and 530c respectively pass in the internal sealing portion 513b may be relatively lowered as compared with the part through which the first and second electrode tabs 520c and 530c do not pass. When it is necessary to supplement electrolyte due to the exhaustion of the electrolyte as the secondary battery 500 may be used, a partial leak of the internal sealing portion 513b may be induced by applying a slight physical force to the electrolyte storage portion 560 of the secondary battery 500. That is, the leak is relatively easily produced at the parts through which the first and second electrode tabs 520c and 530c respectively pass in the internal sealing portion 513b. The leak acts as a path of the electrolyte 30, and thus the electrolyte 30 flows in the first and second accommodating portions 511a and 511b, thereby supplementing the electrolyte.

While the present invention has been described in connection with certain exemplary embodiments, it is to be understood that the invention is not limited to the disclosed embodiments, hut, on the contrary, is intended to cover various modifications and equivalent arrangements included within the spirit and scope of the appended claims, and equivalents thereof.

What is claimed is:

1. A secondary battery, comprising:
at least two electrode assemblies positioned in parallel and having a space between the electrode assemblies;
at least two electrode tabs contained within the at least two electrode assemblies, and
a battery case having at least one accommodating portion containing the at least two electrode assemblies.

2. The secondary battery recited in claim 1, wherein said electrode tabs exit a first of the at least two electrode assemblies and enter a second of the at least two electrode assemblies, the electrode tabs extend through the second of the at least two electrode assemblies and exit the battery case.

3. The secondary battery recited in claim 1, further comprising:
a spacer contained within said space between the electrode assemblies.

4. The secondary battery recited in claim 3, wherein said spacer contains at least two mounting portions accommodating said electrode tabs on at least one surface of said spacer.

5. The secondary battery recited in claim 3, wherein said spacer contains at least two mounting portions accommodating said electrode tabs in an interior of said spacer.

6. The secondary battery recited in claim 5, wherein said at least two mounting portions comprise at least one orifice in the spacer.

7. The secondary battery recited in claim 1, said at least one accommodating portion of the battery case, further comprises:
a first accommodating portion containing a first of the at least two electrode assemblies; and
a second accommodating portion containing a second of the at least two electrode assemblies,
wherein the first and second accommodating portions are separated from each other via sealing portions within the battery case.

8. The secondary battery recited in claim 7, wherein the first accommodating portion has approximately a size and shape of the first electrode assembly and a second accommodating portion has approximately the size and shape of the second electrode assembly.

9. The secondary battery of claim 1, wherein the electrode tabs extend through longitudinally opposite sides of the battery case and through both of the two electrode assemblies disposed between the longitudinally opposite sides.

10. The secondary battery recited in claim 7, a spacer contained within said space between the electrode assemblies.

11. The secondary battery recited in claim 7, further comprising:
an electrolyte storage portion located between the first and the second accommodating portions.

12. The secondary battery recited in claim 1, wherein the battery case further comprises:
a cover;
a main body; and
a sealing portion formed by sealing at least a portion of the cover and at least a portion of the main body,
wherein the cover and main body have affixed an electrolyte injection portion for injection of electrolyte into the battery case.

13. The secondary battery recited in claim 12, wherein said electrolyte injection portion is connected to the space between the electrode assemblies.

14. The secondary battery recited in claim 1, further comprising:
a safety member provided in the battery case positioned to correspond to the space.

15. The secondary battery recited in claim 12, wherein said electrolyte injection portion comprises the sealing portion.

16. The secondary battery recited in claim 10, wherein said spacer contains at least two mounting portions on at least one surface of said spacer accommodating said electrode tabs.

17. The secondary battery recited in claim 10, wherein said at least two mounting portions comprise at least one orifice in the spacer.

18. The secondary battery recited in claim 16, wherein said at least two mounting portions having a same shape as each of the electrode tabs.

19. The secondary battery recited in claim 4, wherein said at least two mounting portions having a same shape as each of the electrode tabs.

20. The secondary battery recited in claim 11, wherein said electrolyte storage portion contains electrolyte.
